(19) United States
(12) Patent Application Publication
(10) Pub. No.: US 2019/0333349 A1
(43) Pub. Date: Oct. 31, 2019

(54) Illuminating Device With Monitoring Alarm Function

(71) Applicant: Dong Guan Bright Yinhuey Lighting Co., Ltd. China, Guang Dong (CN)

(72) Inventor: Kevin Hsu, Taichung (TW)

(21) Appl. No.: 15/962,070

(22) Filed: Apr. 25, 2018

(51) Int. Cl. G08B 13/19; F21V 23/04; F21V 21/26; F21V 33/00

(52) U.S. Cl. CPC G08B 13/19; F21V 23/0471; F21S 8/036; F21V 33/0076; F21V 21/26

(57) ABSTRACT

An illuminating device includes a lighting unit and a monitoring alarm unit connected with the lighting unit. The monitoring alarm unit includes a spotlight, a PIR (passive infrared) detector and a main board. The spotlight is electrically connected with the main board. The PIR detector is electrically connected with the main board. The PIR detector detects a foreign infrared signal and feedbacks the infrared signal to the main board, and the main board controls operation of the spotlight according to the infrared signal of the PIR detector. Thus, when the PIR detector detects an infrared signal of a human body, the spotlight emits light beams toward a predetermined direction.

### BACKGROUND OF THE INVENTION

### 1. Field of the Invention

The present invention relates to an illuminating device and, more particularly, to an illuminating device with a monitoring alarm function.

### 2. Description of the Related Art

A conventional lighting device, such as a ceiling fitting, a ground insert lamp, a wall fitting, a post lantern, a hanging pendant, a projection light or the like, comprises an LED functioning as a light source to provide a lighting effect. However, the conventional lighting device only provides an illuminating function and does not have a monitoring alarm function, thereby limiting the versatility of the conventional lighting device. Thus, it is necessary to additionally mount a surveillance system to provide a monitoring alarm function, thereby increasing the cost, and thereby causing inconvenience to the user.

### BRIEF SUMMARY OF THE INVENTION

The primary objective of the present invention is to provide an illuminating device with a PIR monitoring alarm function.

In accordance with the present invention, there is provided an illuminating device comprising a lighting unit and a monitoring alarm unit connected with the lighting unit. The monitoring alarm unit includes a spotlight, a PIR (passive infrared) detector and a main board. The spotlight is electrically connected with the main board. The PIR detector is electrically connected with the main board. The PIR detector detects a foreign infrared signal and feedbacks the infrared signal to the main board, and the main board controls operation of the spotlight according to the infrared signal of the PIR detector. Thus, when the PIR detector detects an infrared signal of a human body, the spotlight emits light beams toward a predetermined direction.

Preferably, the lighting unit includes a lamp body and a light source mounted on the lamp body. The monitoring alarm unit is mounted on a bottom of the lamp body.

Preferably, the monitoring alarm unit further includes a fixture. The PIR detector is mounted on the fixture. The spotlight is mounted on the fixture and is located at a bottom of the PIR detector.

Preferably, the fixture is movably mounted on the bottom of the lamp body. The fixture is rotatable about an axis of the lamp body to adjust a lighting angle of the spotlight.

According to the primary advantage of the present invention, the lighting unit and the monitoring alarm unit are combined, and the monitoring alarm unit includes the spotlight and the PIR detector, so that the illuminating device provides illuminating and monitoring alarm functions simultaneously, thereby enhancing the versatility of the illuminating device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a schematic operational view of an illuminating device in accordance with the preferred embodiment of the present invention.

FIG. 2 is a perspective view of a monitoring alarm unit of the illuminating device in accordance with the preferred embodiment of the present invention.

### DETAILED DESCRIPTION OF THE INVENTION

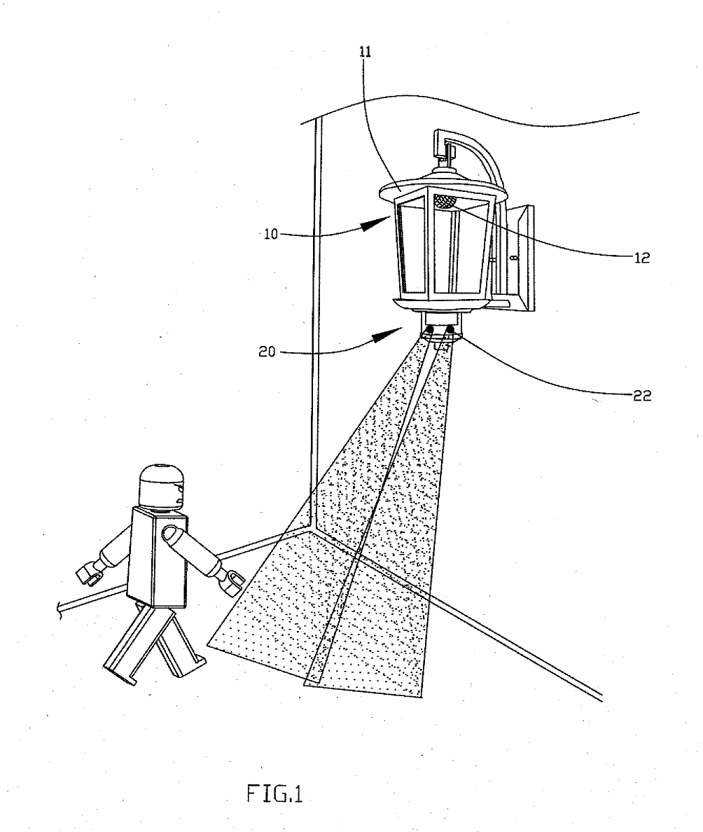

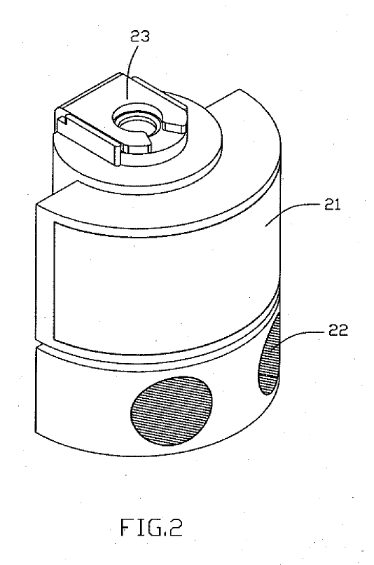

Referring to FIGS. 1 and 2, an illuminating device in accordance with the preferred embodiment of the present invention comprises a lighting unit 10 and a monitoring alarm unit 20 connected with the lighting unit 10.

The lighting unit 10 includes a ceiling fitting, a ground insert lamp, a wall fitting, a post lantern, a hanging pendant, a projection light or the like.

The monitoring alarm unit 20 includes a spotlight 21, a PIR (passive infrared) detector 22 and a main board. The spotlight 21 is electrically connected with the main board. The PIR detector 22 is electrically connected with the main board. The PIR detector 22 detects a foreign infrared signal and feedbacks the infrared signal to the main board, and the main board controls operation of the spotlight 21 according to the infrared signal of the PIR detector 22. Thus, when the PIR detector 22 detects an infrared signal of a human body, the spotlight 21 emits light beams toward a predetermined direction.

In the preferred embodiment of the present invention, the lighting unit 10 includes a lamp body 11 and a light source 12 mounted on the lamp body 11. The monitoring alarm unit 20 is mounted on a bottom of the lamp body 11.

In the preferred embodiment of the present invention, the monitoring alarm unit 20 further includes a fixture 23. The PIR detector 22 is mounted on the fixture 23. The spotlight 21 is mounted on the fixture 23 and is located at a bottom of the PIR detector 22.

In the preferred embodiment of the present invention, the fixture 23 is movably mounted on the bottom of the lamp body 11. The fixture 23 is rotatable about an axis of the lamp body 11 to adjust a lighting angle of the spotlight 21.

In the preferred embodiment of the present invention, the lamp body 11 includes a support bracket and a frame mounted on the support bracket. The light source is mounted on the frame. The support bracket has an end provided with a hook. The frame has an upper end provided with a hanging ring hooked on the hook of the support bracket to attach the frame to the support bracket.

In operation, when the PIR detector 22 detects the infrared signal of the human body, the spotlight 21 emits strong light beams toward the predetermined direction as shown in FIG. 1, so as to achieve a warning function. At this time, the fixture 23 is rotatable about the axis of the lamp body 11 to adjust the lighting angle of the spotlight 21, thereby achieving the warning function of different angles, and thereby enhancing the lighting effect of the spotlight 21

Accordingly, the lighting unit 10 and the monitoring alarm unit 20 are combined, and the monitoring alarm unit 20 includes the spotlight 21 and the PIR detector 22, so that the illuminating device provides illuminating and monitoring alarm functions simultaneously, thereby enhancing the versatility of the illuminating device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An illuminating device comprising:
a lighting unit; and
a monitoring alarm unit connected with the lighting unit;
wherein:
the lighting unit includes a lamp body and a light source mounted on the lamp body;
the monitoring alarm unit is mounted on a bottom of the lamp body;
the monitoring alarm unit is directly combined with the lamp body;
the monitoring alarm unit includes a spotlight, a PIR (passive infrared) detector and a main board;
the spotlight is electrically connected with the main board directly;
the PIR detector is electrically connected with the main board;
the PIR detector detects a foreign infrared signal and feedbacks the foreign infrared signal to the main board, and the main board controls operation of the spotlight according to the foreign infrared signal of the PIR detector; and
when the PIR detector detects an infrared signal of a human body, the main board directly drives the spotlight, and the spotlight emits light beams which are directed toward a fixed direction and cover a fixed area.

2. (canceled)

3. The illuminating device of claim 1, wherein:
the monitoring alarm unit further includes a fixture directly attached to the lamp body;
the PIR detector is mounted on the fixture and faces sideward; and
the spotlight is mounted on the fixture and is located at a bottom of the PIR detector.

4. The illuminating device of claim 3, wherein:
the fixture directly attaches the PIR detector to the lamp body;
the PIR detector protrudes outward from the fixture;
the spotlight protrudes outward from the fixture;
the fixture is movably mounted on the bottom of the lamp body; and
the fixture is rotatable about an axis of the lamp body to adjust a lighting angle of the spotlight.

5. The illuminating device of claim 3, wherein the spotlight is located between the PIR detector and the light source.

6. The illuminating device of claim 1, wherein the spotlight of the monitoring alarm unit is spaced from and located under the light source of the lighting unit.
